(19) United States
(12) Patent Application Publication
(10) Pub. No.: US 2015/0127527 A1
(43) Pub. Date: May 7, 2015

(54) PAYMENT PROCESSING SYSTEM AND METHOD

(71) Applicant: Knox Payments, Inc., Richmond, VA (US)

(72) Inventor: THOMAS E. EIDE, HENRICO, VA (US)

(21) Appl. No.: 14/530,691

(22) Filed: Oct. 31, 2014

Related U.S. Application Data
(60) Provisional application No. 61/898,513, filed on Nov. 1, 2013.

(51) Int. Cl. G06Q 20/40; G06Q 20/02; G06Q 20/10

(52) U.S. Cl. CPC G06Q 20/4016; G06Q 20/10; G06Q 20/023
USPC 705/39

(57) ABSTRACT

A computer-implemented method, system, and computer program product for processing a payment comprises: receiving a transaction request from a payee, the transaction request including an identifier of a payor, and identifier of the payee, and a payment amount; prompting the payor to input login credentials for a payor-identified funding institution; receiving the login credentials from the payor; transmitting the login credentials to the funding institution; receiving, from the funding institution, information regarding one or more accounts at the funding institution linked to the payor; prompting the payor to select an account; and generating a fund transfer request to instruct a financial clearing house to transfer funds in the amount of the payment amount from the selected account to a receiving account associated with the payee.

### CROSS-REFERENCE TO RELATED APPLICATIONS

This application claims priority to pending U.S. Provisional Application Ser. No. 61/898,513, filed Nov. 1, 2013, the contents of which are incorporated herein by reference in its entirety.

### FIELD OF THE INVENTION

This invention relates to payment processing systems.

### BACKGROUND

There are many ways to make payments for purchases, whether the purchases are online, on the phone, or in-person. Such purchases may be paid for using credit cards, debit cards, or specialized payment services such as PayPal, depending on the nature of the purchase. However, there are several concerns about and/or shortcomings to using these payment methods, both for the merchant (payee) and the purchaser (payor).

For example, a purchaser may be reluctant to provide his/her credit card information over the internet because of the many data breaches that have occurred that have allowed criminals to obtain such credit card information from merchants' computer systems. Additionally, some purchasers may not have a credit card.

Some merchants may be reluctant to accept credit card payments because of the high transaction fees charges by the credit card providers. Payments from credit card providers to merchants can take several days, disrupting a merchant's cash flow.

As such, it would be desirable to have a payment processing system and method capable of enabling secure, reliable payments from payors to payees, without using credit cards, with reduced risk of unauthorized access to payor payment data, and with reduced costs.

### BRIEF SUMMARY

In one embodiment of the invention, a computer-implemented method for processing a payment comprises: receiving a transaction request from a payee, the transaction request including an identifier of a payor, and identifier of the payee, and a payment amount; prompting the payor to input login credentials for a payor-identified funding institution; receiving the login credentials from the payor; transmitting the login credentials to the funding institution; receiving, from the funding institution, information regarding one or more accounts at the funding institution linked to the payor; if the one or more accounts comprise two or more accounts, prompting the payor to select one of the two or more accounts; if the one or more accounts comprise two or more accounts, receiving the selection of one of the two or more accounts from the payor; and generating a fund transfer request to instruct a financial clearing house to transfer funds in the amount of the payment amount from (a) the selected account if the one or more accounts comprise two or more accounts or (b) the account if the one or more accounts comprise only one account to a receiving account associated with the payee.

Prompting the payor to input login credentials for a payor-identified funding institution may comprise (a) transmitting a uniform resource locator (URL) link to the payor in an electronic message, (b) directly serving a uniform resource locator (URL) link to the payor on a website of the payee, or (c) displaying the prompt on a mobile device of the payor using a mobile device app.

The information regarding one or more accounts at the funding institution linked to the payor may comprise one or more of a type of account, a full or partial account number, and a balance.

The method may further comprise receiving information regarding the payor from the funding institution and transmitting the received information regarding the payor to the payee, the received information regarding the payor comprising one or more of a name of the payor, a mailing address of the payor, a telephone number of the payor, or an email address of the payor.

The method may further comprise determining a least cost routing option for transferring funds in the amount of the payment amount from (a) the selected account if the one or more accounts comprise two or more accounts or (b) the account if the one or more accounts comprise only one account to a receiving account associated with the payee.

The method may further comprise determining a likelihood that the transaction request is valid and not fraudulent.

Determining a likelihood that the transaction request is valid and not fraudulent may comprise validating that the payor is a true owner of the one or more accounts at the funding institution linked to the payor.

Validating that the payor is a true owner of the one or more accounts at the funding institution linked to the payor may comprise: validating that the login credentials are valid and authentic; and/or validating that the login credentials match credentials established by a person that creates, maintains or utilizes those credentials when accessing financial data from the funding institution.

Determining a likelihood that the transaction request is valid and not fraudulent may comprise validating that a device the payor is presenting for payment is owned by the payor by validating that login credentials established for the device match login credentials provided by the payor, and/or validating that login credentials established to access mobile records of a mobile device match login credentials provided by the payor.

Determining a likelihood that the transaction request is valid and not fraudulent may comprise determining a location and a time of initiation of the transaction request and determining a probability that initiation of the transaction request could have been made from the location at the time.

Determining a probability that initiation of the transaction request could have been made from the location at the time may comprise one or more of comparing the location and time of the transaction request to a location and a time of a prior transaction request and determining a probability of the payor having been able to travel from the location of the prior transaction request to the location of the transaction request in a time elapsed between the time of the prior transaction request and the time of the transaction request; comparing the location and time of the transaction request to locations and times of historical transaction requests to determine a transaction request location trend; or comparing the location and time of the transaction request to locations and times of historical transaction requests to identify location differences between payments to the payee.

Determining a likelihood that the transaction request is valid and not fraudulent may comprise validating that an identification of the payor is valid by matching one or more details of any physical identification document to corresponding details provided from an issuing authority of the identification document or from public records.

Determining a likelihood that the transaction request is valid and not fraudulent may comprise prompting the payor to input one or more items of personal information in response to specific inquiries and validating that personal information input by the payor in response to the specific inquires matches corresponding information for the payor accessed from one or more third-party websites.

Determining a likelihood that the transaction request is valid and not fraudulent may comprise determining a trade of the payee and comparing the transaction request to historical payment habits of other payors within the trade.

Determining a likelihood that the transaction request is valid and not fraudulent may comprise comparing a type of the transaction request to historical use of transaction requests of the same type by the payor.

The method o may further comprise determining a likelihood that proper funds to complete the transaction request exist and will exist at a time of the fund transfer request by one or more of: determining current and available balances of all of the payor's accounts with the payor's funding institution and all of the payee's accounts with a receiving institution of the payee; determining transaction history for all of the payor's accounts with the payor's funding institution and all of the payee's accounts with the receiving institution of the payee; determining a number of failed transaction or failed presentment attempts on all of the payor's accounts with the payor's funding institution and all of the payee's accounts with a receiving institution of the payee; determining regularly scheduled credit or debits and their associated impact on the current or future balances of all of the payor's accounts with the payor's funding institution and all of the payee's accounts with a receiving institution of the payee; determining a period of time since all of the payor's accounts with the payor's funding institution have been established and since all of the payee's accounts with a receiving institution of the payee have been established; determining any recent and historical viewable activity on predefined social media and career-related websites for the payor and the payee; or determining any recent and historical criminal activity of the payor and the payee.

In addition to the payment processing method, as described above, other aspects of the present invention are directed to corresponding systems and computer program products for processing payments.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a high level flowchart of a method of processing payments, in accordance with embodiments of the present invention.

FIGS. 2-8 are flowcharts illustrating various features of embodiments of the present invention.

FIG. 9 is a schematic block diagram of a computer network in which embodiments of the present invention may operate; and

FIG. 10 is a schematic block diagram of a computer in the network of FIG. 9.

### DETAILED DESCRIPTION

Embodiments of the invention enable payment processing via ACH (“automated clearing house”) transfer of live funds from a payor's existing bank account to a payee, without the need for a separate account with the vendor (payee), without the need for a credit or debit card (or to provide a credit or debit card number to the vendor (payee)), a credit or debit card payment network, or the accompanying fees. A payee may send its customer (payor) an SMS text message with a link or an email with a link, or may serve that link to that payor on the payee's web site. Alternatively, the system may directly route the payor to a log-in screen for the payor's own bank account. In this example, once a single account is linked for a payor user, the system will determine and return all available accounts to the payor user for selection of a bank or credit card account to fund the transaction. Once a payment account is chosen, the system will determine the least-cost routing for the payee to receive the transfer of funds from the selected account. So, for example, where a payor enters or identifies a credit card account to the system, embodiments of the invention may use the credit card account data for verification of the payor's identity, but can also present the payor user with multiple other accounts that can be used to fund the transaction, such as a checking or savings account. Where a checking or savings account is selected, the system's least-cost analysis will elect the means by which payment is processed, such as direct ACH rather than a debit card that may be linked to that account.

Security and anti-fraud goals will be served by the invention's analysis of the payor's activity across multiple bank and credit card accounts, as well as available location data, to determine to a high degree of probability that the payor is in fact the owner of the account being used to make the payment.

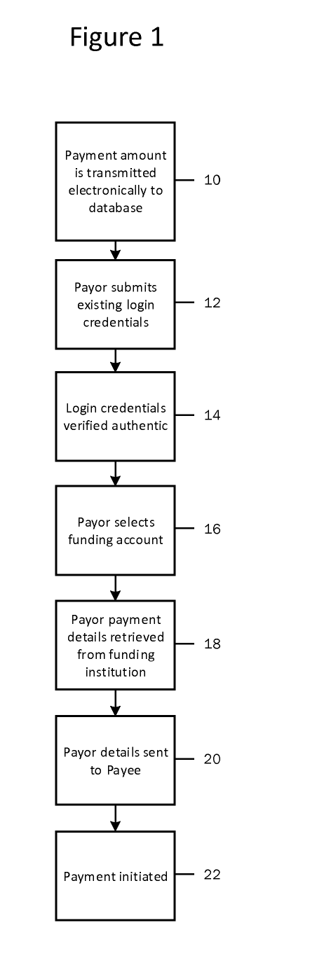

Referring now to FIG. 1, a high level flowchart illustrates a method of processing payments, in accordance with embodiments of the present invention. Typically in response to a customer (hereinafter “payor”) attempting to purchase a good or service from a merchant or otherwise provide a payment to another party (hereinafter “payee”), the payee displays or sends a request for payment electronically (including transaction amount) to a computing system provided by a third party payment processor (hereinafter “computing system” or “third party computing system”). Block 10. The payor then observes or receives a request electronically from the third party computing system. Such a request may be sent via a link in a text message or email, or provided directly to the payor on the payee's website. The payor identifies the funding institution (e.g., bank) from which funds for payment should be taken, submits and sends login credentials used to access financial data or other data related to assets or valuables maintained at the funding institution to the computing system. Block 12. The computing system validates authenticity and accuracy of payor-presented login credentials by establishing a socket connection to the funding institution, transmitting payor-presented login credentials to the funding institution and validating that the response from said socket connection contains the proper data validating that the credentials match those established by the owner of that account with funding institution. Block 14. In certain instances, the funding institution, through established socket connection, may transmit certain multi-factor authentication requests. The computing system presents a data request to payor for the payor to select the funding account, such that the payor may initiate and submit a response to computing system. Block 16. The computing system transmits the payor-presented response to the funding institution through the established socket connection. The computing system matches the funding institution response with known valid responses. The computing system receives payor details as presented by the funding institution, which may include but is not limited to: name of account holder, present and past mailing address of account holder, all current, pending and past debits and credits, email address of account holder, telephone number(s) of account holder, account numbers assigned to certain assets and liabilities maintained for the benefit of the account holder. Block 18. Some details about the payor, such as address, may be retrieved from the funding institution and sent to the payee, thereby enabling the payee to have such information without requiring the payor to provide it directly to the payor (such as by establishing an account with the payor). Block 20. The computing system creates a payment record for payment containing payee name, payee account number, depositing institution identifier, payor name, payor account number and funding institution identifier. The computing system transmits payment record to a financial transaction processor (such as ACH) for settlement. Block 22.

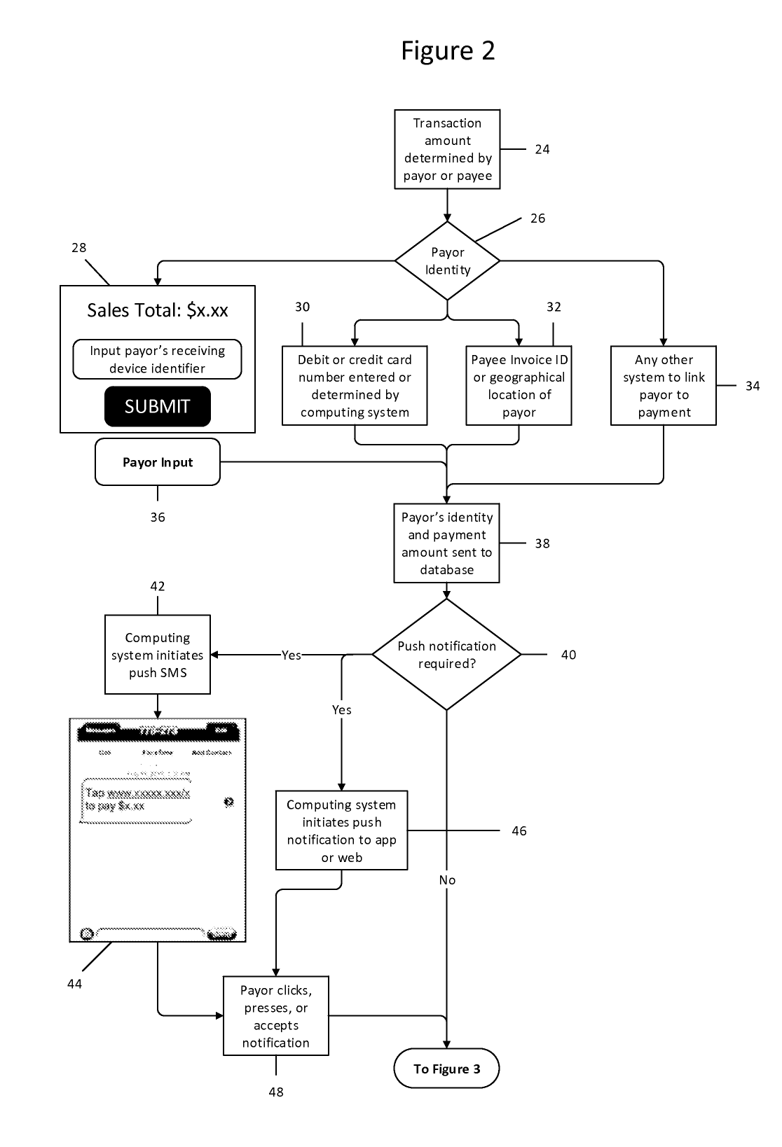

Referring now to FIGS. 2-8, various features of embodiments of the present invention are illustrated in greater detail. FIG. 2 illustrates various ways the computing system can identify the payor. The transaction amount (the amount to be paid by the payee to the payor) is determined either by the payor or (more typically in a commercial transaction) by the payee. Block 24. The payor then needs to be identified. Block 26. There are many different ways that the payor can be identified, four of which are illustrated. One, the payor may be prompted to input an identifier for a receiving device of the payor, such as a phone number at which the payor may receive text messages or an email address. Block 28. The payor may enter that information and press a submit button such that the input is provided to the computing system. Block 36. Two, the payor's debit or credit card number may be entered by the payor or otherwise determined by the computing system. Block 30. Three, the payor may be identified via a payee invoice ID (such as an account number) or geographical location of the payor. Block 32. Four, any other suitable system may be used to link the payor to the payment to be made. Block 34.

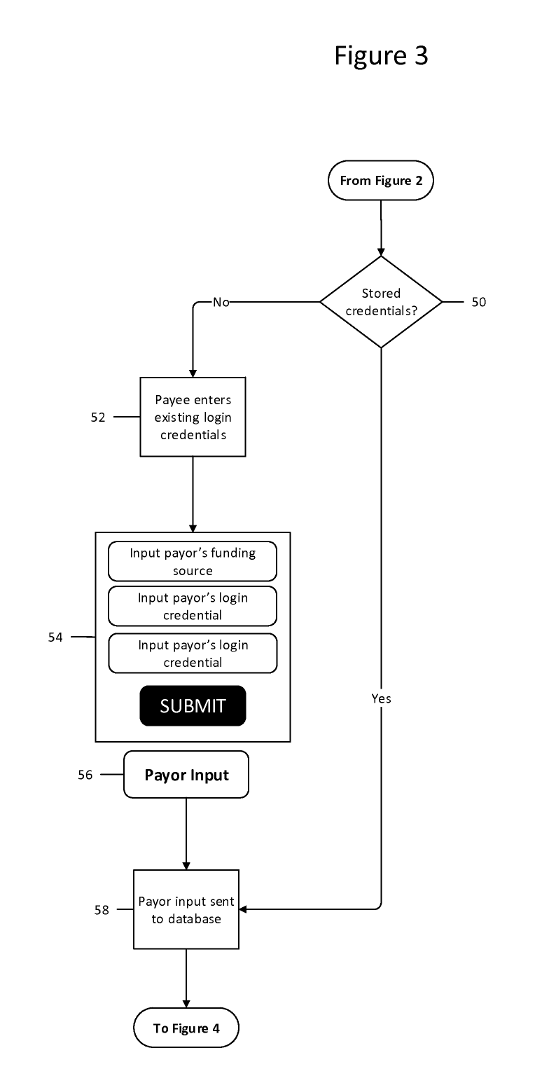

Once determined, the payor's identity and the payment amount are sent to the computing system. Block 38. It is then determined if a push notification to the payor is required. Block 40. If the payor is interacting with the payee's website to process an order, such a push notification is typically not necessary, and the process moves on to the payor inputting login credentials (see FIG. 3). A push notification may be required, for example, if the payee is making a purchase at the payee's physical location and is not interacting with the payee's website. If a push notification is required, the computing system sends such a push notification to the payor, for example, via an SMS text message (block 42), a smartphone or tablet app (block 46), a web page (block 46) or an email (not shown). Block 44 shows an example of how such a text message may appear. The push notification will typically include a URL link to the payment processing system and the amount to be paid. The payor clicks, presses, or otherwise accepts the notification to proceed with the payment process. Block 48.

FIG. 3 illustrates one way a payor can input existing login credentials into the computing system. The computing system determines if the payor's login credentials for the funding institution are already stored in the computing system's database (which is not required). Block 50. If so, those credentials are retrieved from the database. If the payor's login credentials for the funding institution are not already stored in the computing system's database, the payor is prompted to input his/her login credentials. Block 52. Block 54 shows an example of how such a prompt may appear. In block 54, the payor is prompted to input the funding source (e.g., a specific bank) and the login credentials (e.g., login name and password) to access the funding source's online account access system. The payor may enter that information and press a submit button such that the input is provided to the computing system. Block 56. Once input, the payor's login credentials for the funding institution are sent to the computing system. Block 58.

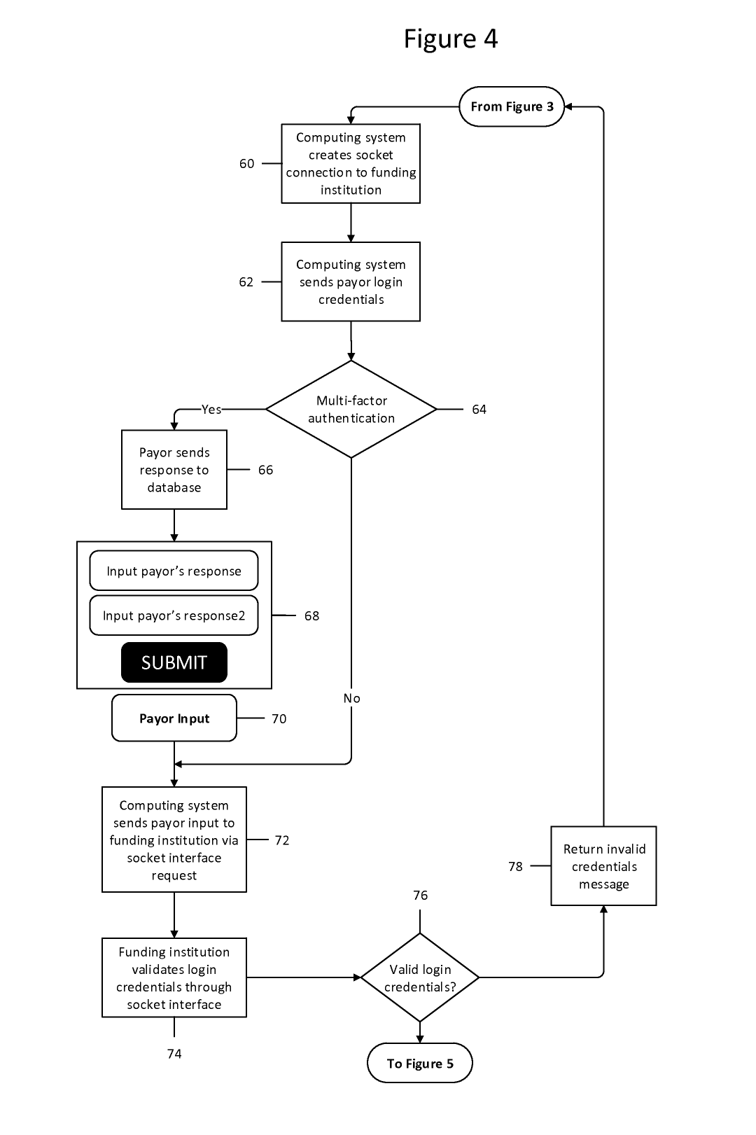

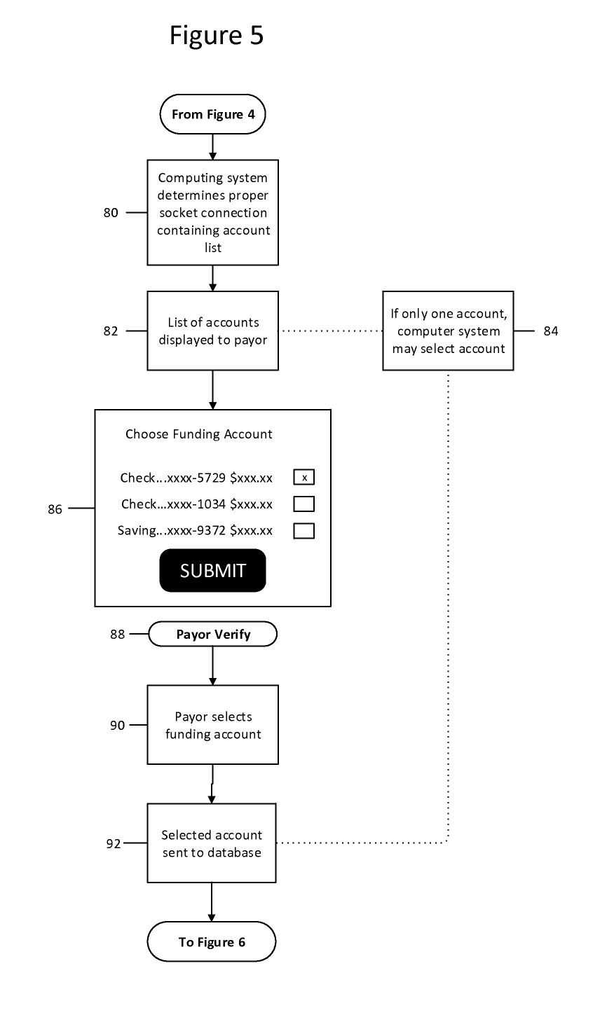

FIG. 4 illustrates one way to communicate the login credentials to the funding institution, including using multi-factor authentication if required. Multi-factor authentication (MFA) requires more than one form of authentication to verify the legitimacy of a transaction. The computing system creates a socket connection to the funding institution that was selected by the payor. Block 60. The computing system sends the login credentials for the funding institution that were input by the payor to the funding institution via the socket connection. Block 62. The computing system determines if multi-factor authentication is required to login to the payor's funding institution. Block 64. If so, the payor is prompted to input his/her additional login information that is required for MFA. Block 66. Block 68 shows an example of how such a prompt may appear. In block 68, the payor is prompted to input responses to two different questions or prompt (e.g., mother's maiden name). The computing system obtains the MFA questions/prompts from the funding institution. The payor may enter that MFA information and press a submit button such that the input is provided to the computing system. Block 70. The payor's login credentials (and MFA responses, if required) are sent by the computing system to the funding institution via the socket connection. Block 72. The funding institution validates the login credentials. Block 74. If the login credentials are not valid (block 76), a message is returned from the funding institution to the computing system indicating so. Block 78. If the login credentials are valid, the process proceeds to FIG. 5 in which the payor selects the specific account from which the payment should be taken.

FIG. 5 illustrates one way the payor may be able to select a funding source (e.g., account) if multiple sources exist. The computing system determines the proper socket connection containing the list of the payor's accounts at the funding institution. Block 80. The list of accounts is displayed for the payor, and the payor is prompted to select the specific account from which the payment should be taken. Block 82. If there is only one account for the payor at that funding institution, the computing system may automatically select that account. Block 84. Block 86 shows an example of how such a display/prompt may appear. In block 86, the payor is prompted to select one of the three displayed accounts. The payor may select one of the accounts (block 90) and press a submit button such that the input is provided to the computing system. Block 88. Once selected, the payor's account is sent to the computing system. Block 92.

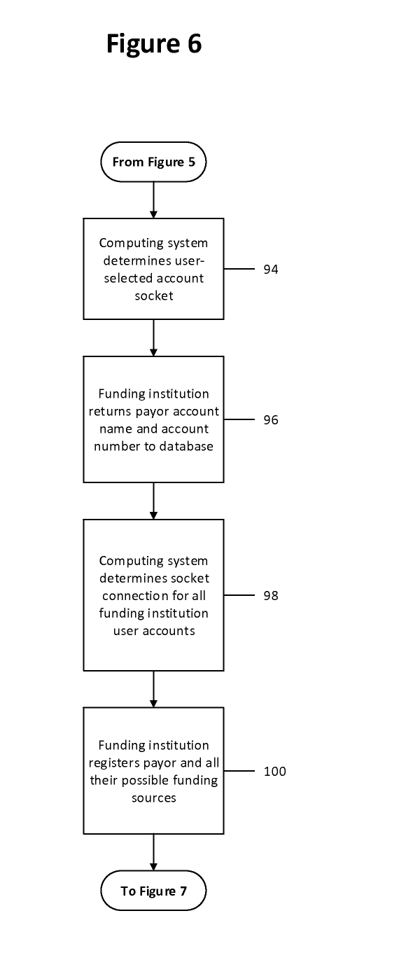

FIG. 6 illustrates one way the computing system negotiates and retrieves payor account details. The computing system determines the appropriate socket connection for the payor-selected account. Block 94. The funding institution returns the payor account name and account number to the computing system. Block 96. The computing system determines the appropriate socket connection for all of the payor's account. Block 98. The funding institution registers the payor with the computing system and all of the possible funding sources (e.g., accounts). Block 100.

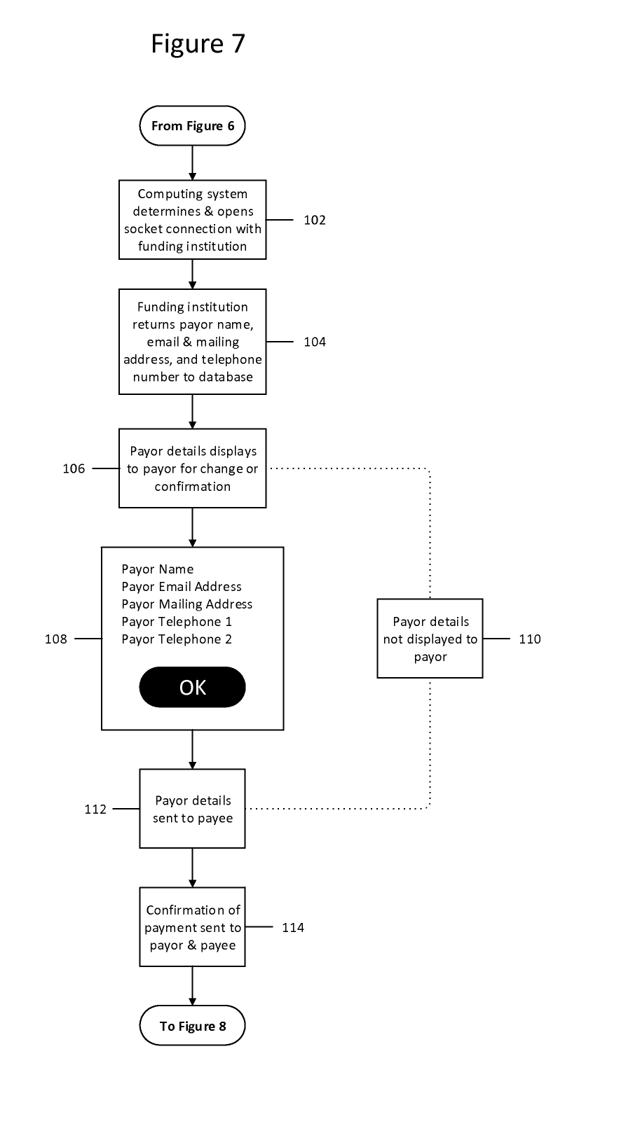

FIG. 7 illustrates one way the payor might change or confirm his/her account information. The computing system determines and opens the appropriate socket connection to the funding institution. Block 102. The funding institution returns the payor's name, mailing address, email address, and telephone number to the computing system. Block 104. These details may be displayed to the payor for confirmation or change. Block 106. The payor is given the opportunity to confirm or change their contact details in case they would like merchandise to be delivered to an alternate location. Alternatively, these details may not be displayed to the payor. Block 110. Block 108 shows an example of how such a display/prompt may appear. In block 108, the payor's information is displayed to allow the payor to confirm the accuracy by pressing an “OK” button. The payor's information is provided to the payee. Block 112. In this regard, the payor may not be required to directly provide such information to the payee. A confirmation of payment is then sent to both the payor and the payee from the computing system. Block 114.

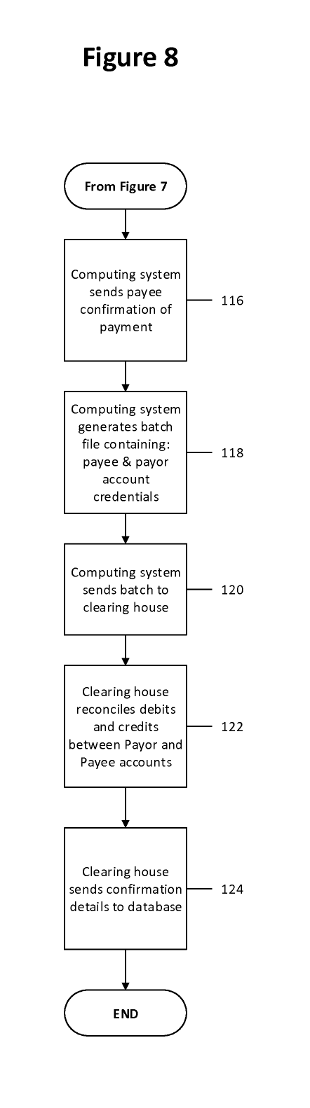

FIG. 8 illustrates one way a payment is processed between payor and payee. The computing system sends confirmation of payment to the payee. Block 116. The computing system generates a batch file containing payee and payor account credentials to enable the payment to be electronically transferred between the payee's funding institution and the payor's bank. Block 118. The computing system sends the batch file to the ACH. Block 120. The ACH reconciles debits and credits between the payor's and the payee's accounts (i.e., the payment due from the payor to the payee is netted against any funds due from the payee to the payor; if no funds are due from the payee to the payor, then the entirety of the payment due from the payor to the payee is transferred from the payor's selected funding account to the payee's specified receiving account). Block 122. The ACH sends confirmation details to the computing system. Block 124.

Embodiments of the invention may use statistical analysis to determine the likelihood that a payment is valid and will successfully conclude. Upon presentment of a potential payment, the computing system may search local and foreign databases for applicable data which may be used to determine the likelihood that a payment is valid and will successfully present to the funding institution without immediate or future retraction. The payor and payee may both be checked against a number of databases to determine the risk involved and if they have been prohibited from doing business. These databases may include Specially Designated Nationals List, Foreign Sanctions Evaders List, Palestinian Legislative Council List, Bureau of Industry and Security Denied Persons List, E-Commerce Control List, Bureau of Industry and Security Unverified List, Office of the Superintendent of Financial Institutions List, Most Wanted Terrorist List, Knox Blox List, as well as business complaints are checked against ftc.gov, BBB, ripoffreport, consumerfinance.gov, complaints.com, and google.com. In one or more embodiments of the invention, computing system determines statistical likelihood that a payment is valid and not made fraudulently by any one or more of the following:
1) Validating the payor is the owner of the financial instrument being presented for payment by:
   a) validating that the login credentials used to access financial data from a particular institution are valid and authentic;
   b) validating that the login credentials match the credentials established by the person that creates, maintains or utilizes those credentials when accessing financial data from that institution (by validating the authentication between the user and the financial institution);
   c) validating that the device the user is presenting for payment (e.g., credit or debit card, check, mobile phone using NFC, mobile phone using geo-location, social media account, electronic wallet, etc.) is owned by the person that established the device by:
      i) validating the credentials used by the payor (i.e. login username and password) match the credentials established for said device;
      ii) validating that the login credentials established to access mobile records of the mobile device matches the login credentials of the holder of said device (if the device has been registered by the payor with the financial institution);
   d) determining the location and time of payment initiation and determining the probability that payment can be made from the location of payment initiation at the time of payment initiation by:
      i) comparing the payment location and time to the locations and times of one or more recent payments (e.g., the most recent payment(s)) and determining the probability of travel (e.g., could the payor have feasibly traveled from the location of the most recent payment to the location of the current payment attempt in the time elapsed between the most recent payment and the current payment attempt?)
      ii) comparing the payment location and time to the locations and times of historical payments determining the probability of future payment location trend; iii) comparing the payment location to historical payment locations of the payor to determine the probability the payor has, is, would or will make a payment in the current payment location (e.g., dramatic geographical differences in payment location to the same payee);
   e) validating that the identification of payor is valid by:
      i) matching the details, whether scanned, by OCR or entered manually, of any physical identification (i.e. driver's license, passport, student ID, etc.) to the details provided from the issuing authority of said identification or public records;
   f) validating that the responses of demand inquires containing personal information typically known by payor (i.e. name of university attended, university major, spouse's maiden name, etc.) match information stored and presented by social media, career-affiliated or other public and private internet websites;
   g) determining the trade of the payee and comparing to the historical payment habits of payor within said trade;
   h) validating the payment event and type as compared to the historical use of payment type by payor;
   i) validating the payor's historical use of credit and credit facilities.

In one or more embodiments of the invention, the computing system determines validity of information based on open socket connections to, direct network connections to, or API calls to one or more of: financial institutions or other fiduciaries of assets, virtual or real; credit bureaus; mobile telephone providers; identity verification providers; credit card processors; public records; and/or money transmitting institutions.

In one or more embodiments of the invention, the computing system determines the statistical likelihood that proper funds to complete the payment exist and will exist at the time of presentment by one or more of the following:
1) determining the current and available balances of all accounts with the funding institution of payor and payee;
2) determining the transaction history for any or all accounts with the funding institution of payor and payee;
3) determining the number of failed transaction or failed presentment attempts on any or all accounts with the funding institution of payor and payee;
4) determining regularly scheduled credit or debits and their reflection on the current or future balances of any accounts with the funding institution of payor and payee;
5) determining the period of time accounts have been established with the funding institution of payor and payee;
6) determining the recent and historical viewable activity of certain social media, career-related and other website data of payor and payee;
7) determining the recent and historical criminal activity of payor and payee;
8) determining the payor's historical use of credit & credit facilities.

In one or more embodiments of the invention, the computing system determines relevance of valid data, assigns a value to each data point, and establishes a statistical analysis of the likelihood the payor is the custodian of the payment device and/or its funding source. This score may be used to approve or decline a transaction. The computing system determines the relevance of current and historical debit and credit data, length of account activity, viewable social behaviors to establish the statistical likelihood that proper funds to complete the payment exist and will exist at the time of presentment. An aggregate risk score of other external third party research databases may be used to approve or decline a transaction.

In one embodiment of the invention, greater values of the risk score correlate with less risk, and approved transactions must have a value of 4 or larger. Such a threshold approval value of 4 means that, based on the following exemplary value assignment rules, the computing system will reject any account that has not aged 60 days (i.e., has not been open for at least 60 days) and any customer that has appeared on any of our internal checks (in addition to any other combination that results in a score of less than 4). In one exemplary embodiment of the invention, the following values may be assigned in the following order: 2.5 points for passing available balance; −10 points if account is not older than 60 days; 0.5 point if account is 61 days to 180 days; 1 point for account age over 180 days; 1 point if average daily balance for 30 days remains >200% of transaction amount; 0.5 point if average daily balance is between 100%-200% of transaction amount; 1 point if monthly flow of credit/debit activity exceeds 1000% of transaction amount; 0.5 point if the monthly flow of credit/debit activity exceeds 500% of the transaction amount; −10 points if the user appears on any automated database check; −1 point if account had insufficient funds within last 60 days; −2 points if account had insufficient funds within last 30 days. Any other suitable risk score factors and value assignments, or combinations thereof, may be used.

In one or more embodiments of the invention, payments can be made using domestic, international, virtual, or faux currency.

In the above description, the payee can be substituted with the payor when the payor is establishing a deposit account with the computing system. This means the payor can have the option to establish an account to receive payments as a payee.

The payor and/or payee may be identified by name, debit or credit card, telephone number, mobile device, email address, social media identity, session id, voice pattern, or other biometric identifier.

The automated clearing house may be a gateway provider, financial institution, payment processor, money transmitter, or the Federal Reserve.

The funding institution may be any commercial financial institution, credit union, money transmitter, holding corporation, lending institution or payment facilitator that's primary business includes holding assets for others including currency and virtual currencies.

A gateway provider is any individual, company or computing application that initiates funds transfers on behalf of its customers.

In a specific use-case of an embodiment of the present invention, a payor presents a credit card for payment to a payee. The payee asks the payor if the payment is debit or credit like the payee might ask today if the payor was to present a debit card only. The payor elects to pay via debit perhaps to avoid paying fees or surcharges assessed normally for the use of credit cards. The payee scans the credit card and presses debit. The payee's payment processor presents the credit card as a debit transaction through the computing system using this invention. The computing system identifies the payor's credit card account number as an account connected to the payor's funding institution. The computing system identifies the funding source of an account with the funding institution or another linked funding institution and determines the statistical likelihood the credit card is being used by an authorized user and the statistical likelihood that funds will be available upon presentment for payment. The computing system initiates and transmits the payment for reconciliation by a clearing house provider or rejects the payment for presentment.

Embodiments of the present invention give organizations and business owners an easy way to take electronic payments without the need for special equipment, physical identification or expensive interchange fees. Embodiments of the present invention allow for one-time and recurring payments on a weekly, monthly, or yearly schedule, which simplifies the payment process for the customer and increases cash flow while reducing cost for the organization and business owner. Recurring payments are ideal for business owners because their customers accept convenience and flexible services that cater to their needs and budget. Organizations benefit from recurring payments with continued support by their donors on a schedule that is convenient and flexible to the donor. Recurring payments for both business owners and organizations increase cash flow with no more late or missed payments, lost checks or costly invoicing processes. Organizations and business owners can eliminate the cost of continually sending paper invoices or checks, save on paper and postage, and lower the cost of marketing and promotional materials.

Embodiments of the present invention can enable PIN-based payments. Using PIN-based payments, payors would no longer need to re-enter their retail banking login credentials for every transaction. The PIN feature allows for the customer to only enter a 4 digit number or pattern sequence to complete the payment transaction. Organizations and business owners benefit from the quick transaction process with increased cash flow from doubling the volume of transactions in the same time as traditional payment methods.

Embodiments of the present invention allow for true mobility of payments. The payors no longer are confined to a physical presentment of a payment object (e.g., check, cash, credit card, etc.) and are no longer required to attain, look up, remember or store a virtual payment object (e.g., credit card number, bank account number, etc.).

Embodiments of the present invention provide an electronic debit network to organizations and businesses utilizing retail internet banking credentials. Organizations and business owners connect sales to their customers through ACH transactions between all U.S. and foreign financial institutions. Organizations and business owners benefit from the mobility of the network and availability of recurring payments with increased revenue because there are less or insignificant transaction, interchange or processing fees. Organizations and business owners benefit from the computing system with all transactions strictly conducted in a PCI and SAS70 compliant environment using the same or higher security as internet banking from U.S. financial institutions. The computing system reduces the payment transaction length for customers of organizations and businesses with an efficient process faster than today's readily available payment platforms.

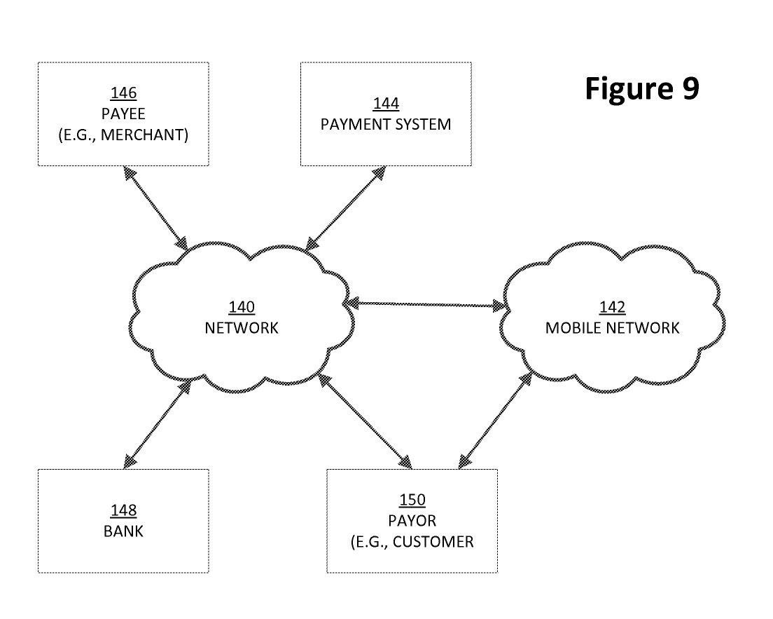

FIG. 9 is a schematic block diagram of a system in which embodiments of the present invention may operate. In the system of FIG. 9, block 144 represent a server(s) upon which the process is executing (i.e., the computing system described above). Block 146 represents, for example, a merchant's (i.e., payor's) order processing server(s). Block 150 represents, for example, a computer or mobile computing device of a customer (i.e., payee). Block 148 represents the funding institution's electronic banking server(s). Communications among the devices involved in the process may occur over network 140. Communications may also occur over mobile network 142 for devices that are so equipped.

The devices in FIG. 9 provide processing, storage, and input/output devices executing application programs and the like. Communications network 140 can be part of the Internet, a worldwide collection of computers, networks, and gateways that currently use the TCP/IP suite of protocols to communicate with one another. The Internet provides a backbone of high-speed data communication lines between major nodes or host computers, comprising thousands of commercial, government, educational, and other computer networks, that route data and messages. However, the devices in FIG. 9 may be linked over any suitable communication network. Mobile network 142 may be any suitable mobile communications/data architecture (such as a mobile telecommunications network adhering to the International Mobile Telecommunications-2000 (also termed 3G) or IMT-Advanced (also termed 4G) standards), in which a mobile telecommunications device communicates.

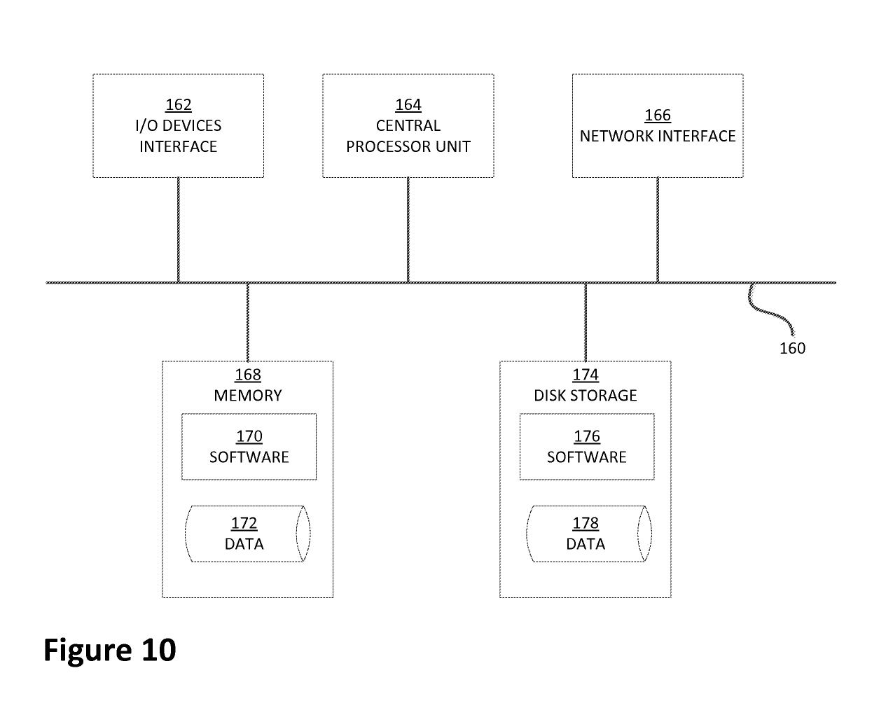

FIG. 10 is a diagram of one possible internal structure of a computer (e.g., computer 150) or server (e.g., server 144) in the system of FIG. 9. Each computer or server typically contains system bus 160, where a bus is a set of hardware lines used for data transfer among the components of a computer. Bus 160 is essentially a shared conduit that connects different elements of a computer system (e.g., processor, disk storage, memory, input/output ports, network ports, etc.) that enables the transfer of information between the elements. Attached to system bus 160 is I/O device interface 162 for connecting various input and output devices (e.g., displays, printers, speakers, microphones, etc.) to the computer. Alternatively, the I/O devices may be connected via one or more I/O processors attached to system bus 160. Network interface 166 allows the computer to connect to various other devices attached to a network (e.g., network 140 of FIG. 9). Memory 168 provides volatile storage for computer software instructions 170 and data 172 used to implement an embodiment of the present invention. Disk storage 174 provides non-volatile storage for computer software instructions 176 and data 178 used to implement an embodiment of the present invention. Central processor unit 164 is also attached to system bus 160 and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium/media having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Other systems, methods, and/or products according to the above embodiments will be or will become apparent to one of ordinary skill in the art upon review of the above description, the following drawings, and any further description. It is intended that all such additional systems, methods, and/or products be included within this description, be within the scope of the present invention, and be protected by the accompanying claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A computer-implemented method for processing a payment, the method comprising:
receiving a transaction request from a payee, the transaction request including an identifier of a payor, and identifier of the payee, and a payment amount;
prompting the payor to input login credentials for a payor-identified funding institution;
receiving the login credentials from the payor;
transmitting the login credentials to the funding institution;
receiving, from the funding institution, information regarding one or more accounts at the funding institution linked to the payor;
if the one or more accounts comprise two or more accounts, prompting the payor to select one of the two or more accounts;
if the one or more accounts comprise two or more accounts, receiving the selection of one of the two or more accounts from the payor; and
generating a fund transfer request to instruct a financial clearing house to transfer funds in the amount of the payment amount from (a) the selected account if the one or more accounts comprise two or more accounts or (b) the account if the one or more accounts comprise only one account to a receiving account associated with the payee.

2. The method of claim 1, wherein prompting the payor to input login credentials for a payor-identified funding institution comprises (a) transmitting a uniform resource locator (URL) link to the payor in an electronic message, (b) directly serving a uniform resource locator (URL) link to the payor on a website of the payee, or (c) displaying the prompt on a mobile device of the payor using a mobile device app.

3. The method of claim 1, wherein the information regarding one or more accounts at the funding institution linked to the payor comprises one or more of a type of account, a full or partial account number, and a balance.

4. The method of claim 1, further comprising:
receiving information regarding the payor from the funding institution and transmitting the received information regarding the payor to the payee, the received information regarding the payor comprising one or more of a name of the payor, a mailing address of the payor, a telephone number of the payor, or an email address of the payor.

5. The method of claim 1, further comprising:
determining a least cost routing option for transferring funds in the amount of the payment amount from (a) the selected account if the one or more accounts comprise two or more accounts or (b) the account if the one or more accounts comprise only one account to a receiving account associated with the payee.

6. The method of claim 1, further comprising:
determining a likelihood that the transaction request is valid and not fraudulent.

7. The method of claim 6, wherein determining a likelihood that the transaction request is valid and not fraudulent comprises validating that the payor is a true owner of the one or more accounts at the funding institution linked to the payor.

8. The method of claim 7, wherein validating that the payor is a true owner of the one or more accounts at the funding institution linked to the payor comprises:
validating that the login credentials are valid and authentic; and/or
validating that the login credentials match credentials established by a person that creates, maintains or utilizes those credentials when accessing financial data from the funding institution.

9. The method of claim 6, wherein determining a likelihood that the transaction request is valid and not fraudulent comprises:
validating that a device the payor is presenting for payment is owned by the payor by validating that login credentials established for the device match login credentials provided by the payor, and/or validating that login credentials established to access mobile records of a mobile device match login credentials provided by the payor.

10. The method of claim 6, wherein determining a likelihood that the transaction request is valid and not fraudulent comprises:
determining a location and a time of initiation of the transaction request and determining a probability that initiation of the transaction request could have been made from the location at the time.

11. The method of claim 10, wherein determining a probability that initiation of the transaction request could have been made from the location at the time comprises one or more of:
comparing the location and time of the transaction request to a location and a time of a prior transaction request and determining a probability of the payor having been able to travel from the location of the prior transaction request to the location of the transaction request in a time elapsed between the time of the prior transaction request and the time of the transaction request;
comparing the location and time of the transaction request to locations and times of historical transaction requests to determine a transaction request location trend; or
comparing the location and time of the transaction request to locations and times of historical transaction requests to identify location differences between payments to the payee.

12. The method of claim 6, wherein determining a likelihood that the transaction request is valid and not fraudulent comprises:
validating that an identification of the payor is valid by matching one or more details of any physical identification document to corresponding details provided from an issuing authority of the identification document or from public records.

13. The method of claim 6, wherein determining a likelihood that the transaction request is valid and not fraudulent comprises:
prompting the payor to input one or more items of personal information in response to specific inquiries;
validating that personal information input by the payor in response to the specific inquires matches corresponding information for the payor accessed from one or more third-party websites.

14. The method of claim 6, wherein determining a likelihood that the transaction request is valid and not fraudulent comprises:
determining a trade of the payee and comparing the transaction request to historical payment habits of other payors within the trade.

15. The method of claim 6, wherein determining a likelihood that the transaction request is valid and not fraudulent comprises:
comparing a type of the transaction request to historical use of transaction requests of the same type by the payor.

16. The method of claim 1, further comprising:
determining a likelihood that proper funds to complete the transaction request exist and will exist at a time of the fund transfer request by one or more of:
determining current and available balances of all of the payor's accounts with the payor's funding institution and all of the payee's accounts with a receiving institution of the payee;
determining transaction history for all of the payor's accounts with the payor's funding institution and all of the payee's accounts with the receiving institution of the payee;
determining a number of failed transaction or failed presentment attempts on all of the payor's accounts with the payor's funding institution and all of the payee's accounts with a receiving institution of the payee;
determining regularly scheduled credit or debits and their associated impact on the current or future balances of all of the payor's accounts with the payor's funding institution and all of the payee's accounts with a receiving institution of the payee;
determining a period of time since all of the payor's accounts with the payor's funding institution have been established and since all of the payee's accounts with a receiving institution of the payee have been established;
determining any recent and historical viewable activity on predefined social media and career-related websites for the payor and the payee; or
determining any recent and historical criminal activity of the payor and the payee.

17. A system for processing a payment, the system comprising, a computer processor, a computer memory and a communication element operatively coupled to the computer processor, the computer memory having disposed within it computer program instructions configured for:
receiving a transaction request from a payee, the transaction request including an identifier of a payor, and identifier of the payee, and a payment amount;
prompting the payor to input login credentials for a payor-identified funding institution;
receiving the login credentials from the payor;
transmitting the login credentials to the funding institution;
receiving, from the funding institution, information regarding one or more accounts at the funding institution linked to the payor;
if the one or more accounts comprise two or more accounts, prompting the payor to select one of the two or more accounts;
if the one or more accounts comprise two or more accounts, receiving the selection of one of the two or more accounts from the payor; and
generating a fund transfer request to instruct a financial clearing house to transfer funds in the amount of the payment amount from (a) the selected account if the one or more accounts comprise two or more accounts or (b) the account if the one or more accounts comprise only one account to a receiving account associated with the payee.

18. The system of claim 17, wherein prompting the payor to input login credentials for a payor-identified funding institution comprises (a) transmitting a uniform resource locator (URL) link to the payor in an electronic message, (b) directly serving a uniform resource locator (URL) link to the payor on a website of the payee, or (c) displaying the prompt on a mobile device of the payor using a mobile device app.

19. The system of claim 17, wherein the information regarding one or more accounts at the funding institution linked to the payor comprises one or more of a type of account, a full or partial account number, and a balance.

20. The system of claim 17, wherein the computer memory having disposed within it computer program instructions further configured for:
receiving information regarding the payor from the funding institution and transmitting the received information regarding the payor to the payee, the received information regarding the payor comprising one or more of a name of the payor, a mailing address of the payor, a telephone number of the payor, or an email address of the payor.

21. The system of claim 17, wherein the computer memory having disposed within it computer program instructions further configured for:
determining a least cost routing option for transferring funds in the amount of the payment amount from (a) the selected account if the one or more accounts comprise two or more accounts or (b) the account if the one or more accounts comprise only one account to a receiving account associated with the payee.

22. The system of claim 17, wherein the computer memory having disposed within it computer program instructions further configured for:
determining a likelihood that the transaction request is valid and not fraudulent.

23. The system of claim 22, wherein determining a likelihood that the transaction request is valid and not fraudulent comprises validating that the payor is a true owner of the one or more accounts at the funding institution linked to the payor.

24. The system of claim 23, wherein validating that the payor is a true owner of the one or more accounts at the funding institution linked to the payor comprises:
validating that the login credentials are valid and authentic; and/or
validating that the login credentials match credentials established by a person that creates, maintains or utilizes those credentials when accessing financial data from the funding institution.

25. The system of claim 22, wherein determining a likelihood that the transaction request is valid and not fraudulent comprises:
validating that a device the payor is presenting for payment is owned by the payor by validating that login credentials established for the device match login credentials provided by the payor, and/or validating that login credentials established to access mobile records of a mobile device match login credentials provided by the payor.

26. The system of claim 22, wherein determining a likelihood that the transaction request is valid and not fraudulent comprises:
determining a location and a time of initiation of the transaction request and determining a probability that initiation of the transaction request could have been made from the location at the time.

27. The system of claim 26, wherein determining a probability that initiation of the transaction request could have been made from the location at the time comprises one or more of:
comparing the location and time of the transaction request to a location and a time of a prior transaction request and determining a probability of the payor having been able to travel from the location of the prior transaction request to the location of the transaction request in a time elapsed between the time of the prior transaction request and the time of the transaction request;
comparing the location and time of the transaction request to locations and times of historical transaction requests to determine a transaction request location trend; or
comparing the location and time of the transaction request to locations and times of historical transaction requests to identify location differences between payments to the payee.

28. The system of claim 22, wherein determining a likelihood that the transaction request is valid and not fraudulent comprises:
validating that an identification of the payor is valid by matching one or more details of any physical identification document to corresponding details provided from an issuing authority of the identification document or from public records.

29. The system of claim 22, wherein determining a likelihood that the transaction request is valid and not fraudulent comprises:
prompting the payor to input one or more items of personal information in response to specific inquiries;
validating that personal information input by the payor in response to the specific inquires matches corresponding information for the payor accessed from one or more third-party websites.

30. The system of claim 22, wherein determining a likelihood that the transaction request is valid and not fraudulent comprises:
determining a trade of the payee and comparing the transaction request to historical payment habits of other payors within the trade.

31. The system of claim 22, wherein determining a likelihood that the transaction request is valid and not fraudulent comprises:
comparing a type of the transaction request to historical use of transaction requests of the same type by the payor.

32. The system of claim 31, wherein the computer memory having disposed within it computer program instructions further configured for:
determining a likelihood that proper funds to complete the transaction request exist and will exist at a time of the fund transfer request by one or more of:
determining current and available balances of all of the payor's accounts with the payor's funding institution and all of the payee's accounts with a receiving institution of the payee;
determining transaction history for all of the payor's accounts with the payor's funding institution and all of the payee's accounts with the receiving institution of the payee;
determining a number of failed transaction or failed presentment attempts on all of the payor's accounts with the payor's funding institution and all of the payee's accounts with a receiving institution of the payee;
determining regularly scheduled credit or debits and their associated impact on the current or future balances of all of the payor's accounts with the payor's funding institution and all of the payee's accounts with a receiving institution of the payee;
determining a period of time since all of the payor's accounts with the payor's funding institution have been established and since all of the payee's accounts with a receiving institution of the payee have been established;
determining any recent and historical viewable activity on predefined social media and career-related websites for the payor and the payee; or
determining any recent and historical criminal activity of the payor and the payee.

33. A computer program product for processing a payment, the computer program product comprising a computer readable storage medium having computer readable program code embodied therewith, the computer readable program code comprising:
computer readable program code configured for receiving a transaction request from a payee, the transaction request including an identifier of a payor, and identifier of the payee, and a payment amount;
computer readable program code configured for prompting the payor to input login credentials for a payor-identified funding institution;
computer readable program code configured for receiving the login credentials from the payor;
computer readable program code configured for transmitting the login credentials to the funding institution;
computer readable program code configured for receiving, from the funding institution, information regarding one or more accounts at the funding institution linked to the payor;
computer readable program code configured for, if the one or more accounts comprise two or more accounts, prompting the payor to select one of the two or more accounts;
computer readable program code configured for, if the one or more accounts comprise two or more accounts, receiving the selection of one of the two or more accounts from the payor; and
computer readable program code configured for generating a fund transfer request to instruct a financial clearing house to transfer funds in the amount of the payment amount from (a) the selected account if the one or more accounts comprise two or more accounts or (b) the account if the one or more accounts comprise only one account to a receiving account associated with the payee.

34. The computer program product of claim 33, wherein prompting the payor to input login credentials for a payor-identified funding institution comprises (a) transmitting a uniform resource locator (URL) link to the payor in an electronic message, (b) directly serving a uniform resource locator (URL) link to the payor on a website of the payee, or (c) displaying the prompt on a mobile device of the payor using a mobile device app.

35. The computer program product of claim 33, wherein the information regarding one or more accounts at the funding institution linked to the payor comprises one or more of a type of account, a full or partial account number, and a balance.

36. The computer program product of claim 33, further comprising:
computer readable program code configured for receiving information regarding the payor from the funding institution and transmitting the received information regarding the payor to the payee, the received information regarding the payor comprising one or more of a name of the payor, a mailing address of the payor, a telephone number of the payor, or an email address of the payor.

37. The computer program product of claim 33, further comprising:
computer readable program code configured for determining a least cost routing option for transferring funds in the amount of the payment amount from (a) the selected account if the one or more accounts comprise two or more accounts or (b) the account if the one or more accounts comprise only one account to a receiving account associated with the payee.

38. The computer program product of claim 33, further comprising:
computer readable program code configured for determining a likelihood that the transaction request is valid and not fraudulent.

39. The computer program product of claim 38, wherein determining a likelihood that the transaction request is valid and not fraudulent comprises validating that the payor is a true owner of the one or more accounts at the funding institution linked to the payor.

40. The computer program product of claim 39, wherein validating that the payor is a true owner of the one or more accounts at the funding institution linked to the payor comprises:
validating that the login credentials are valid and authentic; and/or
validating that the login credentials match credentials established by a person that creates, maintains or utilizes those credentials when accessing financial data from the funding institution.

41. The computer program product of claim 38, wherein determining a likelihood that the transaction request is valid and not fraudulent comprises:
validating that a device the payor is presenting for payment is owned by the payor by validating that login credentials established for the device match login credentials provided by the payor, and/or validating that login credentials established to access mobile records of a mobile device match login credentials provided by the payor.

42. The computer program product of claim 38, wherein determining a likelihood that the transaction request is valid and not fraudulent comprises:
determining a location and a time of initiation of the transaction request and determining a probability that initiation of the transaction request could have been made from the location at the time.

43. The computer program product of claim 42, wherein determining a probability that initiation of the transaction request could have been made from the location at the time comprises one or more of:
comparing the location and time of the transaction request to a location and a time of a prior transaction request and determining a probability of the payor having been able to travel from the location of the prior transaction request to the location of the transaction request in a time elapsed between the time of the prior transaction request and the time of the transaction request;
comparing the location and time of the transaction request to locations and times of historical transaction requests to determine a transaction request location trend; or
comparing the location and time of the transaction request to locations and times of historical transaction requests to identify location differences between payments to the payee.

44. The computer program product of claim 38, wherein determining a likelihood that the transaction request is valid and not fraudulent comprises:
validating that an identification of the payor is valid by matching one or more details of any physical identification document to corresponding details provided from an issuing authority of the identification document or from public records.

45. The computer program product of claim 38, wherein determining a likelihood that the transaction request is valid and not fraudulent comprises:
prompting the payor to input one or more items of personal information in response to specific inquiries;
validating that personal information input by the payor in response to the specific inquires matches corresponding information for the payor accessed from one or more third-party websites.

46. The computer program product of claim 38, wherein determining a likelihood that the transaction request is valid and not fraudulent comprises:
determining a trade of the payee and comparing the transaction request to historical payment habits of other payors within the trade.

47. The computer program product of claim 38, wherein determining a likelihood that the transaction request is valid and not fraudulent comprises:
comparing a type of the transaction request to historical use of transaction requests of the same type by the payor.

48. The computer program product of claim 33, further comprising:
computer readable program code configured for determining a likelihood that proper funds to complete the transaction request exist and will exist at a time of the fund transfer request by one or more of:
determining current and available balances of all of the payor's accounts with the payor's funding institution and all of the payee's accounts with a receiving institution of the payee;
determining transaction history for all of the payor's accounts with the payor's funding institution and all of the payee's accounts with the receiving institution of the payee;
determining a number of failed transaction or failed presentment attempts on all of the payor's accounts with the payor's funding institution and all of the payee's accounts with a receiving institution of the payee;
determining regularly scheduled credit or debits and their associated impact on the current or future balances of all of the payor's accounts with the payor's funding institution and all of the payee's accounts with a receiving institution of the payee;
determining a period of time since all of the payor's accounts with the payor's funding institution have been established and since all of the payee's accounts with a receiving institution of the payee have been established;
determining any recent and historical viewable activity on predefined social media and career-related websites for the payor and the payee; or
determining any recent and historical criminal activity of the payor and the payee.
